(19) United States
(12) Patent Application Publication
(10) Pub. No.: US 2012/0205138 A1
(43) Pub. Date: Aug. 16, 2012

(54) FLEXIBLE FLAT CABLE USING ROUND CONDUCTORS

(76) Inventors: Hun Kuen KIM, Seoul (KR); Da Won CHANG, Bucheon-si (KR); Soon Bo KWON, Seoul (KR)

(21) Appl. No.: 13/326,729

(22) Filed: Dec. 15, 2011

(30) Foreign Application Priority Data
Feb. 16, 2011 (KR) 10-2011-0013633

(51) Int. Cl. H01B 7/08

(52) U.S. Cl. 174/117 F

(57) ABSTRACT

The present invention relates to a flexible flat cable using round conductors and, more particularly, to the continuous fabrication of flexible flat cables each using round conductors, wherein the terminal unit of the flexible flat cable has a straight angle conductor form. The flexible flat cable using the round conductors according to the present invention comprises the round conductors and an upper base film and a lower base film covering upper and lower parts of the round conductors, wherein the terminal unit of the flexible flat cable is formed of the straight angle conductors formed by processing the round conductors, and the lower base film supporting the straight angle conductors is integrally formed over the entire length of the flexible flat cable.

### BACKGROUND OF THE INVENTION

1. Field of the Invention

The present invention relates to a flexible flat cable using round conductors and, more particularly, to the continuous fabrication of flexible flat cables each using round conductors, wherein the terminal unit of the flexible flat cable has a straight angle conductor form.

2. Background of the Related Art

A flexible flat cable is inserted into a connector and chiefly used to transfer signals between electronic components. The flexible flat cable is fabricated by attaching base films, etc. on the upper and lower parts of a linear conductor for transferring the signals. The linear conductor is formed of a round conductor having a round section or a straight angle conductor having a square section. The round conductor is inserted into a press fit blade provided in the contact of the connector or the fixing groove of a printed circuit board, and the straight angle conductor is chiefly used in such a way as to be press-fitted into the terminal unit of the connector and contacted therewith.

Japanese Patent Laid-Open Publication No. 2002-56721 (Document 1) discloses a flexible flat cable in which part of a round conductor is rolled into a straight angle conductor and base films are then attached on the upper and lower parts of the straight angle conductor so that a user can randomly select the round conductor or the straight angle conductor. Document 1 discloses a technical spirit in which a region where the round conductor or the straight angle conductor is placed is removed, if necessary, and the round conductor or the straight angle conductor exposed by removing the base films on the upper and lower parts is connected to a connector to a printed circuit board. Furthermore, if the straight angle conductor is exposed and used, the end of the flexible flat cable is processed in a form that a lower reinforcement plate is additionally attached to the straight angle conductor, and this flexible flat cable is inserted into the connector.

Furthermore, Japanese Patent Laid-Open Publication No, 2010-49971 (Document 2) and Japanese Patent Laid-Open Publication No. 2010-192287 (Document 3) disclose that a round conductor is exposed by removing a base film at the end of a flexible flat cable, the exposed round conductor is transformed into a straight angle conductor, and the position of the straight angle conductor is fixed by using an additional reinforcement plate at the bottom of the straight angle conductor.

The prior arts disclose that the end of the flexible flat cable is formed by determining and cutting a specific length of the flexible flat cable and the previously processed straight angle conductor is exposed at the end of the flexible flat cable (Document 1) or the round conductor is exposed at the end of the flexible flat cable and then processed into the straight angle conductor through rolling (Documents 2 and 3). In this case, productivity is inevitably very low because the base film at the end of the flexible flat cable must be removed one by one by cutting the flexible flat cable to a specific length. Furthermore, a laser, etc. is used to remove the base film in order to remove the linear conductor without damage. Accordingly, there are problems in that the cutting face of the base film made of synthetic resin, etc. is not fine and deformation, such as that the surface of the remaining base film becomes rough owing to heat, is generated.

Furthermore, as an interval between the terminals of various connectors is recently narrowed about 0.4 to 0.5 mm, the width of a straight angle conductor exposed at the end of a flexible flat cable used in the connector must be very narrow. Furthermore, the straight angle conductor must be placed very accurately according to the interval of the terminal. If the straight angle conductor is exposed and the reinforcement plate is then attached as in the prior arts, a problem arises because accurate arrangement and fixing of the straight angle conductor is very difficult.

### PRIOR ART DOCUMENT

### Patent Document

(Patent Document 1) [Document 1] JP 2002-56721 A (Feb. 22, 2002). Paragraphs [0005]-[0006] of p. 2
(Patent Document 2) Paragraph [0021] of p. 3 and all the drawings
(Patent Document 3) [Document 2] JP 2010-49971 A (Mar. 4, 2010) Paragraph [0012] of p. 3 and Paragraph [0033] of p. 5
(Patent Document 4) [Document 3] JP 2010-192287 A (Sep. 2, 2010) Paragraph [0015] of p. 5 and Paragraph [0021] of p. 6
(Patent Document 5) All the drawings

### SUMMARY OF THE INVENTION

Accordingly, the present invention has been made in view of the above problems occurring in the prior art, and it is an object of the present invention to provide a flexible flat cable in which a terminal unit can be formed more finely, the thickness of the flexible flat cable can be made thin by facilitating impedance control, and a shield layer on the outside of the flexible flat cable does not come into contact with a linear conductor.

A flexible flat cable using round conductors according to the present invention comprises the round conductors and an upper base film and a lower base film covering upper and lower parts of the round conductors, wherein a straight angle conductor formed by rolling part of each of the round conductors is exposed in the terminal unit of the flexible flat cable before the upper base film and the lower base film are coated, the straight angle conductors exposed in the terminal unit are supported by the lower base film in a form of being attached to the lower base film when the round conductors and the straight angle conductors are attached to the lower base film, and the lower base film is integrally formed over the entire length of the flexible flat cable including the terminal unit.

It is preferred that an insulating film of a belt form be inserted into the end of the upper base film and part of the insulating film of the belt form be not covered with the upper base film.

It is preferred that an insulating coating layer be formed on the outer surface of each of the round conductors.

### BRIEF DESCRIPTION OF THE DRAWINGS

Further objects and advantages of the invention can be more fully understood from the following detailed description taken in conjunction with the accompanying drawings in which:

FIG. 1 is a perspective view of a conventional flexible flat cable.

FIG. 2 is a cross-sectional view of the conventional flexible flat cable.

FIG. 3 is a perspective view of a flexible flat cable according to an embodiment of the present invention.

FIG. 4 is a cross-sectional view of the flexible flat cable according to the embodiment of the present invention.

FIG. 5 is a cross-sectional view of a flexible flat cable according to another embodiment of the present invention.

FIGS. 6, 7, and 8 are schematic diagrams of a method of manufacturing a flexible flat cable according to the present invention.

FIG. 9 is a diagram showing the final processing step of the flexible flat cable according to the present invention.

<Description of reference numerals of principal
elements in the drawings>

| | |
|---|---|
| 10: straight angle conductor | 20: round conductor |
| 100: upper film layer | 110: upper base film |
| 200: lower film layer | 210: lower base film |
| 300: reinforcement unit | 500: insulating film |

### DETAILED DESCRIPTION OF EMBODIMENTS

Exemplary embodiments of the present invention will now be described in detail with reference to the accompanying drawings.

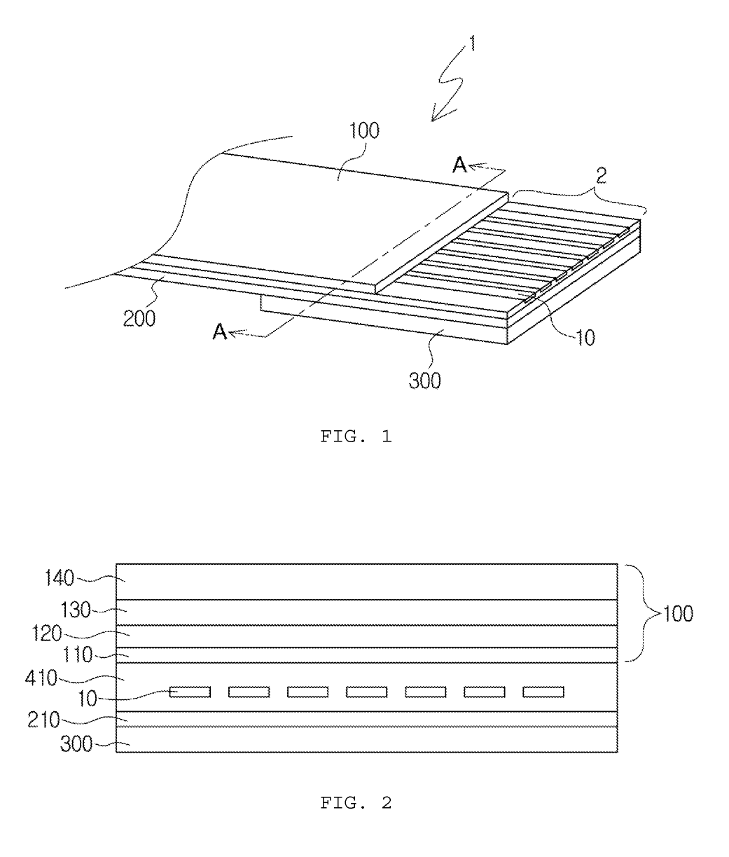

FIG. 1 is a perspective view of a conventional flexible flat cable using straight angle conductors as linear conductors. The straight angle conductors 10 are fixed between an upper film layer 100 and a lower film layer 200 by means of an adhesive or thermal fusion between the films. Furthermore, in the terminal unit 2 of the straight angle conductors 10 formed at the end of the flexible flat cable, the upper film layer does not exist, and the straight angle conductors 10 is externally exposed. A reinforcement unit 300 supporting the terminal unit is attached to the bottom of the lower film layer 200 at the end of the flexible flat cable.

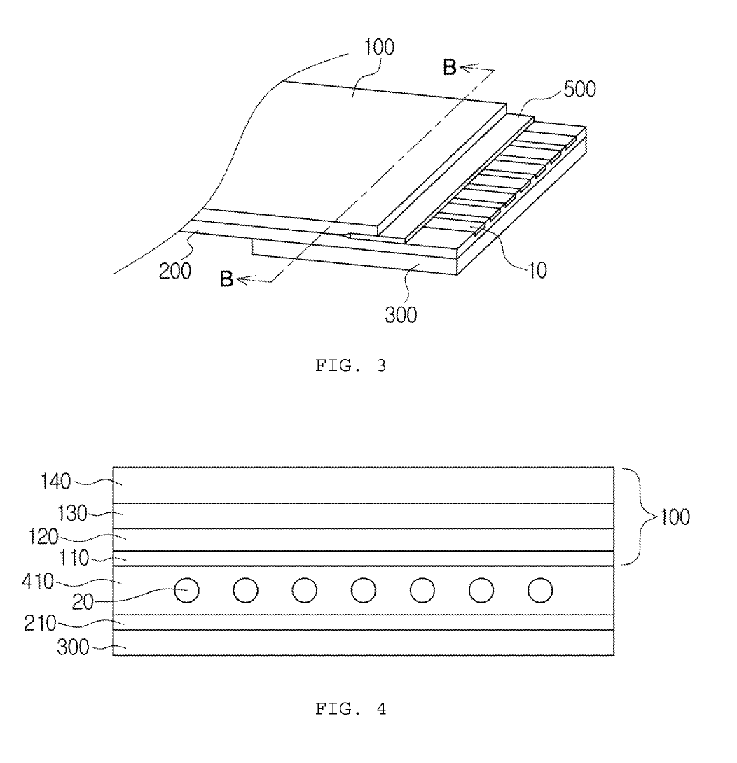

FIG. 2 is a cross-sectional view (section A-A in FIG. 1) of the conventional flexible flat cable. The straight angle conductors 10 are arranged between an upper base film 110 and a lower base film 210, and the upper base film 110 and the lower base film 210 are adhered to each other by an adhesion unit 410.

An impedance control film 120 made of dielectric material is attached on the top surface of the upper base film 110 in order to control impedance. An aluminum foil unit 130 responsible for ground and shield functions is attached to the top surface of the impedance control film 120. A cover film 140 is attached to the top surface of the aluminum foil unit 130. The upper base film 110, the impedance control film 120, the aluminum foil unit 130, and the cover film 140 are adhered to one another by means of thermal fusion or an adhesive, but the remaining adhesion units other than the adhesion unit 410 between the upper base film 110 and the lower base film 210 are not shown in FIG. 2. Furthermore, the upper base film 110, the impedance control film 120, the aluminum foil unit 130, and the cover film 140 form the upper film layer 100.

Although the lower film layer 200 is illustrated to include only the lower base film 210 in FIG. 2, an impedance control film, an aluminum foil unit, and a cover film may be attached to the bottom of the lower film layer, thus forming the lower film layer 200.

If differential impedance is matched with 100 ohm in FIG. 2, the thickness of the cover film 140 is 50 μm, the thickness of the aluminum foil unit 130 is 7 μm, the thickness of the impedance control film 120 is 150 to 180 μm, the thickness of the upper base film 110 is 12 μm, the thickness of the adhesion unit 410 is 68 μm, and the thickness of the lower base film 210 is 12 μm, so that the total thickness becomes 299 to 329 μm. The straight angle conductors has a thickness of 35 μm and a width of about 0.3 mm.

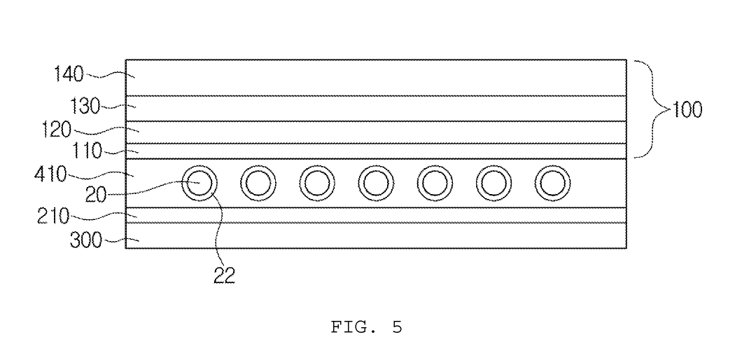

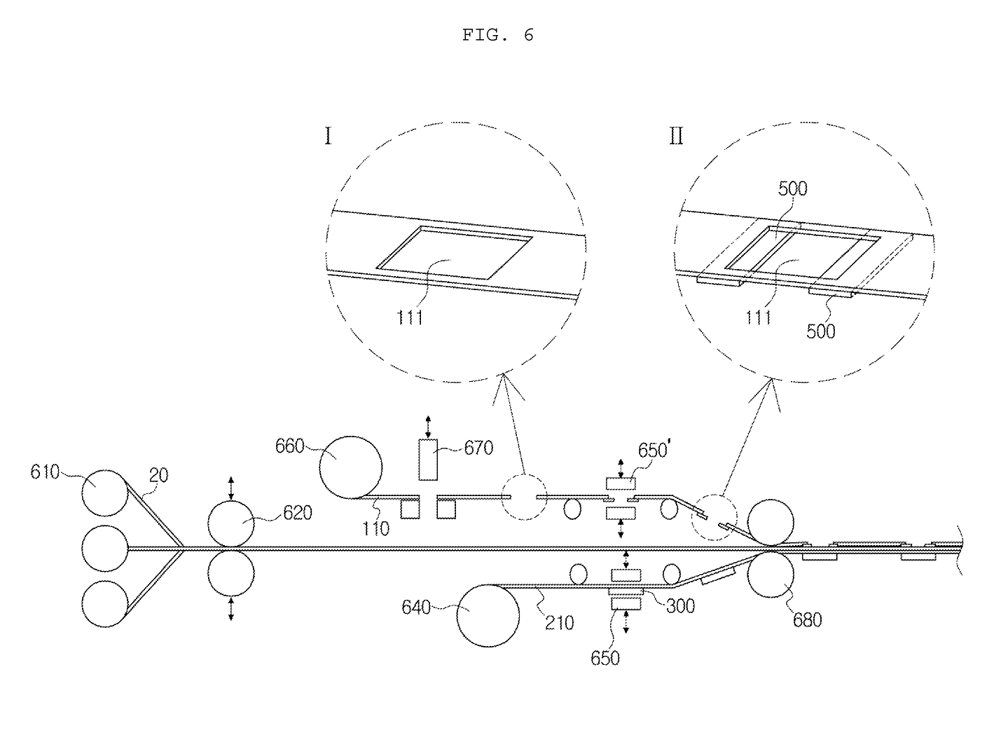

FIG. 3 is a perspective view of a flexible flat cable according to an embodiment of the present invention. FIG. 4 is a B-B cross-sectional view of FIG. 3.

The flexible flat cable according to the embodiment of the present invention is different from the conventional flexible flat cable of FIG. 2 in that the linear conductors of the remaining parts other than the terminal unit are formed of round conductors and an insulating film of a belt form is inserted into the end of the upper base film. Part of the insulating film of a belt form is exposed toward the terminal unit without being covered with the upper base film.

If differential impedance is matched with 100 ohm in FIG. 4,

the thickness of the cover film 140 is 50 μm, the thickness of the aluminum foil unit 130 is 7 μm, the thickness of the impedance control film 120 is 32 to 50 μm, the thickness of the upper base film 110 is 23 μm, the thickness of the adhesion unit 410 is 80 μm, and the thickness of the lower base film 210 is 23 μm, and the diameter of the round conductor 20 is 120 μm so that the total thickness becomes 258 to 276 μm.

Therefore, the thickness of the flexible flat cable can be reduced as compared with the conventional flexible flat cable using all the linear conductors as the straight angle conductors.

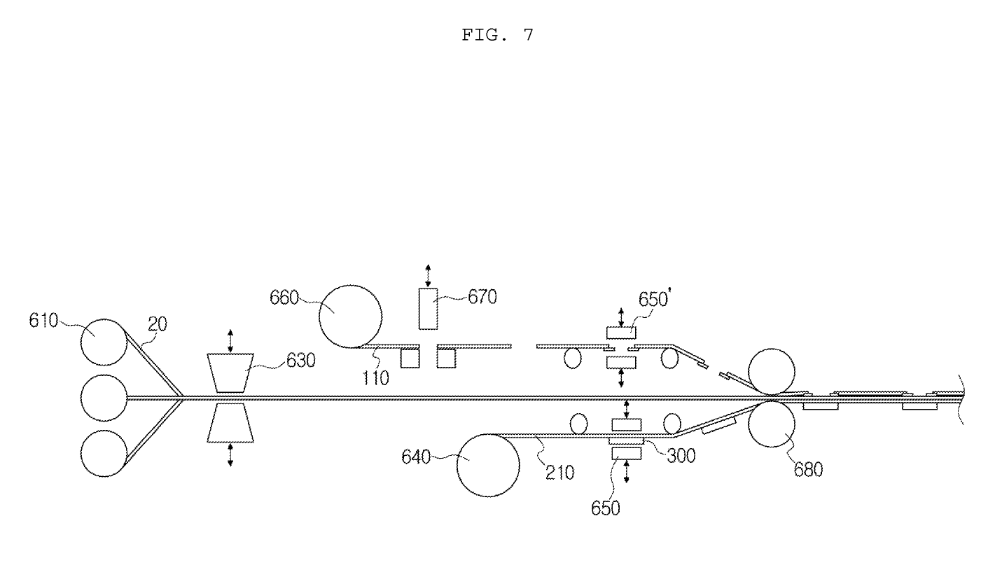

FIG. 5 is a cross-sectional view of a flexible flat cable according to another embodiment of the present invention. An insulating coating layer 22 having a thickness of about 10 μm is formed on the outer surface of each of round conductors 20. If the insulating coating layer 22 made of dielectric material is included, the thickness of an impedance control film 120 can be made thin about 12 to 20 μm. Accordingly, the thickness of the flexible flat cable can be made thin because the flexible flat cable has a total thickness of 235 to 243 μm.

Furthermore, an insulating film 500 of a belt form is inserted between an upper base film 110 and straight angle conductors 10, and part of the insulating film 500 is exposed toward the terminal unit without being covered with the upper base film. In this case, if the top surface of an upper film layer 100 is formed of an aluminum foil unit, the generation of a short, occurring because the terminal unit is folded while using the flexible flat cable and the aluminum foil unit and the straight angle conductors 10 come into contact with each other, can be prevented.

A method of manufacturing the flexible flat cable using the round conductors according to the present invention is described below.

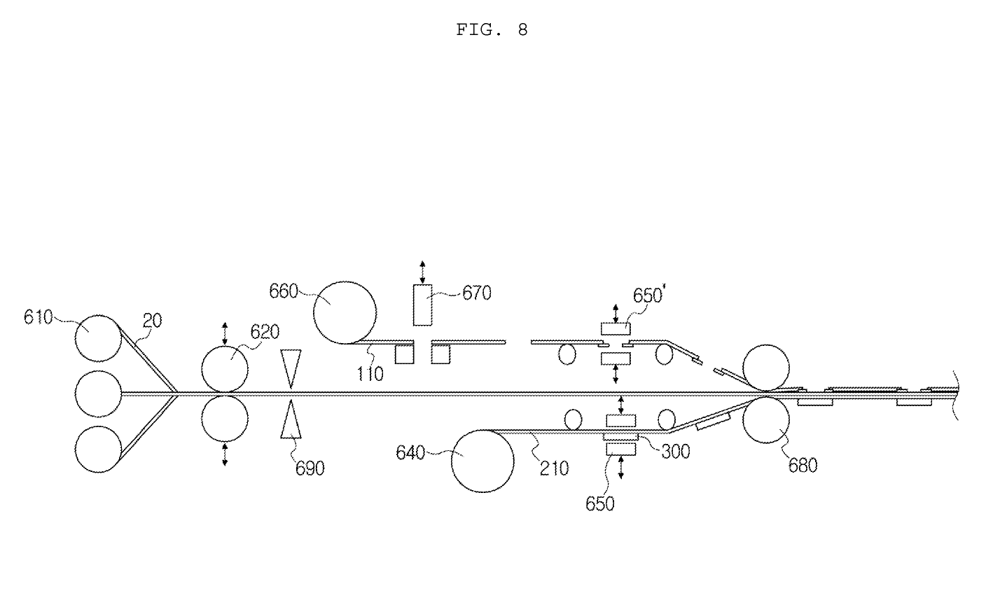

FIGS. 6, 7, and 8 are schematic diagrams of the method of manufacturing the flexible flat cable according to the present invention.

The round conductors 20 are supplied from bobbins 610 on which the round conductors 20 are wound (Step 1). Some of the supplied round conductors 20 are processed into the straight angle conductors to be used in the terminal unit. For this processing, the round conductors are periodically pressurized by using rollers (620 of FIG. 6) or presses (630 of FIG. 7) (Step 2).

The lower base film 210 is supplied from a bobbin 640 on which the lower base film 210 is wound. The reinforcement unit 300 is attached to the bottom of the lower base film 210 by using a thermal fusion device 650 while the lower base film 210 is supplied. The reinforcement unit 300 is attached to a position where the end of the flexible flat cable is formed (Step 3).

The upper base film 110 is supplied from a bobbin 660 on which the upper base film 110 is wound. The supplied upper base film 110 perforates a terminal exposure unit 111 by means of a perforator 670 (refer to an enlarged diagram I of FIG. 6). The terminal exposure unit 111 from which the upper base film 110 has been removed is for exposing the straight angle conductor 10 in the terminal unit (Step 4). The insulating film 500 of a belt form is attached to the bottom of the end of the upper base film by means of a thermal fusion device 650 (refer to an enlarged diagram II of FIG. 6). If the flexible flat cable without the insulating film 500 according to the embodiment of the present invention is fabricated, a step of attaching the insulating film can be omitted.

The round conductor processed at step 2 is inserted between the lower base film 210 and the upper base film 110 experienced by the steps. The straight angle conductors are adhered to the terminal exposure unit 111 processed at step 4 so that the straight angle conductors are placed in the terminal exposure unit 111 (Step 5). This adhesion is performed by an adhesive or thermal fusion. If the adhesive is used, a process of coating the adhesive is included before the adhesion. In FIGS. 6, 7, and 8, the thermal fusion using thermal fusion rollers 680 is shown.

If the insulating coating layer 22 is formed on the outer surface of the round conductors 20 as in FIG. 5, a step of removing the insulating coating layer 22 of a part to be processed into the straight angle conductors or processed into the straight angle conductors is further included after step 1 and before step 5. Here, the insulating coating layer 22 may be removed by using the blade of a knife 690 shown in FIG. 8 or various means, such as a laser device.

Although the supply of the impedance control film, the aluminum foil unit, and the cover film is not shown in FIGS. 6, 7, and 8, a person having ordinary skill in the art who understands the description of steps 3 and 3 of supplying the upper and lower base films can also understand a method of adding films (not shown), such as the impedance control film, the aluminum foil unit, and the cover film.

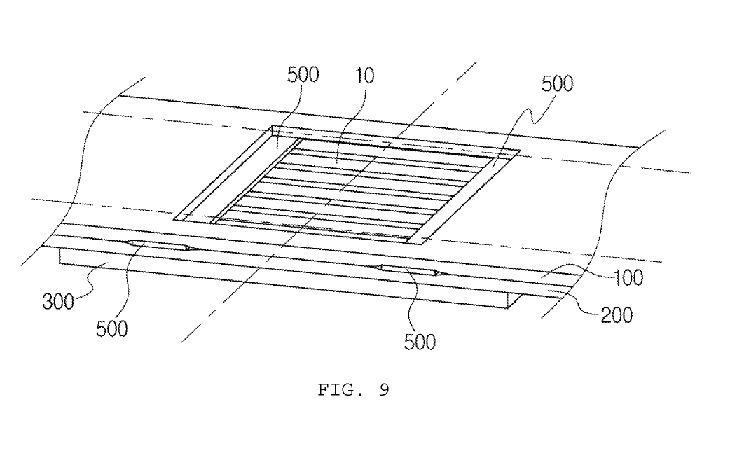

When the flexible flat cable obtained by the manufacturing method of FIGS. 6, 7, and 8 is cut along a line indicated by a chain dashed line in FIG. 9, the flexible flat cable of a form, such as that shown in FIG. 3, can be obtained.

As described above, according to the flexible flat cable of the present invention, the terminal unit can be formed more finely, and the manufacturing cost can be reduced because cheap round conductors can be used as compared with the conventional flexible flat cable using all the linear conductors formed of the straight angle conductors. Furthermore, the thickness of the flexible flat cable can be made thin because of easy impedance control, and a short can be prevented because the shield layer on a surface of the flexible flat cable does not come into contact with the linear conductors.

1. A flexible flat cable using round conductors, comprising the round conductors and an upper base film and a lower base film covering upper and lower parts of the round conductors,
wherein a straight angle conductor formed by rolling part of each of the round conductors is exposed in a terminal unit of the flexible flat cable before the upper base film and the lower base film are coated,
the straight angle conductors exposed in the terminal unit are supported by the lower base film in a form of being attached to the lower base film when the round conductors and the straight angle conductors are attached to the lower base film, and
the lower base film is integrally formed over an entire length of the flexible flat cable including the terminal unit.

2. The flexible flat cable as claimed in claim 1, wherein:
an insulating film of a belt form is inserted into an end of the upper base film, and
part of the insulating film of the belt form is not covered with the upper base film.

3. The flexible flat cable as claimed in claim 2, wherein an insulating coating layer is formed on an outer surface of each of the round conductors.

4. The flexible flat cable as claimed in claim 1, wherein an insulating coating layer is formed on an outer surface of each of the round conductors.
